(19) United States
(12) Patent Application Publication
(10) Pub. No.: US 2009/0124454 A1
(43) Pub. Date: May 14, 2009

(54) CONTROLLER OF VEHICLE AUTOMATIC TRANSMISSION

(75) Inventors: Atsushi Tabata, Aichi (JP); Ryuji Ibaraki, Aichi (JP); Tooru Matsubara, Aichi (JP); Yukihiko Ideshio, Shizuoka (JP); Hiroyuki Shibata, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, AICHI (JP)

(21) Appl. No.: 12/090,980

(22) PCT Filed: Oct. 26, 2006
(86) PCT No.: PCT/JP2006/321345

§ 371 Date: Apr. 21, 2008

(30) Foreign Application Priority Data
Oct. 26, 2005 (JP) 2005-312065

(51) Int. Cl. F16H 61/12; F16H 48/06

(52) U.S. Cl. 477/37; 475/153

(57) ABSTRACT

A control system capable of ensuring an engine braking force and a drive force even in case a failure occurs in a speed change ratio control or a deceleration control of an automatic transmission. The control system includes: a failure detecting mechanism for detecting a failure to set any of predetermined speed change ratios; and a speed change commanding mechanism for outputting a speed change command to set a speed change ratio larger than the current speed change ratio in accordance with a signal outputted when the failure detecting mechanism detects the failure.

### TECHNICAL FIELD

This invention relates to a control system for an automatic vehicle transmission to which a power is inputted and which outputs the power changed after carrying out a speed change operation, and especially to a control system for controlling a drive torque upon occurrence of a failure.

### BACKGROUND ART

An automatic transmission for a vehicle is adapted to set a speed change ratio thereof in accordance with a running condition of the vehicle such as a vehicle speed, drive demand and so on. A fuel economy of the vehicle is improved according to a variousness of settable speed change ratio. Therefore, in recent years, a continuously variable transmission capable of varying a speed change ratio has been used in a vehicle. Additionally, for the purpose of downsizing and weight saving of the continuously variable transmission, there has been proposed a system in which a hybrid (i.e., a power distribution) mechanism is combined with a geared transmission.

One example of a system comprising a hybrid mechanism and a geared transmission is disclosed in Japanese Patent Laid-Open No. 2003-127681. According to the system disclosed in Japanese Patent Laid-Open No. 2003-127681, an internal combustion engine is connected with a carrier of a planetary gear mechanism, and a first motor/generator is connected with a sun gear of the planetary gear mechanism. Also, a ring gear is connected with a member of an input side of a geared automatic transmission. A member of an output side of the automatic transmission is connected with a propeller shaft, and a second motor/generator is connected with the propeller shaft. Thus, according to this drive unit for a hybrid vehicle, the planetary gear mechanism functions as a distribution mechanism distributing an engine power to the first motor/generator and to the transmission. That is, a revolution frequency of the ring gear, i.e., an input revolution of the transmission connected with the ring gear is varied continuously by changing a revolution frequency of the first motor/generator. Therefore, the planetary gear mechanism and the first motor/generator function as a continuously variable transmission. Consequently, a total speed change ratio of the drive unit for the hybrid vehicle is determined by the speed change ratio of the planetary gear mechanism functioning as a continuously variable transmission and the gear stage of the transmission arranged on the output side of the planetary gear mechanism.

According to the system taught by Japanese Patent Laid-Open No. 2003-127681, in case an intrinsic speed change ratio cannot be set due to a trouble in the automatic transmission constituting a drive line or in the control system thereof, the speed change ratio is controlled to reduce the drive torque so as to restrain a running of the vehicle. A concept of such control is to stop the vehicle by degrading a running performance of the vehicle in case some kind of trouble (i.e., a failure) occurs in the automatic transmission or in a control device thereof. Therefore, when a failure occurs in the system taught by Japanese Patent Laid-Open No. 2003-127681, a total speed change ratio determined by both of a speed change ratio of the planetary gear mechanism of the power distribution mechanism and a gear stage of the transmission is reduced. In this situation, if the second motor/generator is functioning as a motor for a torque assisting purpose, an output torque thereof is also reduced.

However, if a speed change ratio or a torque of the assist prime mover is reduced to stop the vehicle when some kind of failure occurs, a negative torque of the engine or the like will not be amplified when transmitted to a wheel. As a result, an engine braking force is weakened comparatively. That is, it is difficult to decelerate the vehicle. In case some sort of failure occurs, it is preferable to perform a retreating running (i.e., a limp-home running). However, if the speed change ratio or the assist torque is reduced, the drive torque of the entire vehicle is reduced. As a result, the retreating running may not be preformed on an upslope or the like.

### DISCLOSURE OF THE INVENTION

The present invention has been conceived noting the technical problems thus far described, and its object is to provide a control system, which is capable of ensuring a braking force and a drive force even if some kind of failure occurs in an automatic transmission or a control device thereof.

In order to achieve the above-mentioned object, according to the present invention, there is provided a control system for an automatic transmission of vehicle, characterized by comprising: a failure detecting means for detecting a failure to set any of predetermined speed change ratios; and a speed change commanding means for outputting a speed change command to set a speed change ratio larger than the current speed change ratio in accordance with a signal outputted when the failure detecting means detects the failure.

The above-mentioned speed change commanding means includes a means for varying the speed change ratio gradually in case of commanding to set a speed change ratio larger than the current speed change ratio.

The speed change commanding means also includes a means for commanding to set a speed change ratio according to the vehicle speed, in case of commanding to set a speed change ratio larger than the current speed change ratio.

In addition to above, according to the invention, the automatic transmission comprises at least two transmission units capable of setting a speed change ratio individually, and the speed change commanding means includes a means outputting a speed change command for increasing a speed change ratio of one of the transmission units in case the failure detecting means detects a failure in any of the transmission units.

In addition to above, according to the invention, the automatic transmission comprises a transmission mechanism for transmitting a power, and a shifting mechanism for a shifting operation of a speed change ratio achieved by the transmission mechanism. The failure detecting means includes a means for detecting a failure in the shifting mechanism.

In addition to above, the speed change commanding means includes a means outputting a speed change command for varying speed change ratios of the transmission units in case the failure detecting means detects a failure in the shifting mechanism.

According to another aspect of the invention, a control system for an automatic transmission of a vehicle capable of controlling a deceleration of the vehicle by varying a negative torque opposite to a torque for running the vehicle, characterized by comprising: a failure detecting means for detecting a failure to set any of predetermined decelerations; and a speed change commanding means for outputting a deceleration command to set a deceleration greater than the current deceleration in accordance with a signal outputted when the failure detecting means detects the failure.

The above-mentioned speed change commanding means includes a means for commanding to vary the deceleration gradually in case of commanding to set the deceleration greater than the current deceleration.

The speed change commanding means also includes a means for commanding to set the deceleration according to the vehicle speed, in case of commanding to set the deceleration greater than the current deceleration.

In addition to above, the automatic transmission comprises a transmission mechanism for transmitting a power, and a decelerating mechanism for a changing operation of the deceleration by varying a torque transmitted through the transmission mechanism. The failure detecting means includes a means for detecting a failure in the decelerating mechanism.

In addition to above, the automatic transmission comprises an electrical continuously variable transmission unit in which a speed change ratio thereof is controlled electrically and varied continuously, and a mechanical transmission unit in which a speed change ratio thereof is changed by changing a torque transmitting point.

Those electrical continuously variable transmission unit and mechanical transmission unit may be connected in tandem so as to input power outputted from any one of those transmissions to the other one.

A total speed change ratio of the automatic transmission may be set by both of the electrical continuously variable transmission unit and mechanical transmission unit.

The electrical continuously variable transmission unit includes a differential gear mechanism, and a single pinion type planetary gear mechanism may be used as the differential gear mechanism.

The mechanical transmission unit comprises two or three sets of planetary gear mechanisms. The planetary gear mechanism may be a single pinion type planetary gear mechanism. In case the mechanical transmission comprises three sets of planetary gear mechanisms: sun gears of a first and a second planetary gear mechanisms are connected with each other; a ring gear of the first planetary gear mechanism, a carrier of the second planetary gear mechanism and a carrier of a third planetary gear mechanism are connected to one another, and those ring gear and carriers are connected with an output member; and a ring gear of the second planetary gear mechanism and a sun gear of the third planetary gear mechanism are connected with each other. In this case, the mechanical transmission unit is provided with: a first clutch selectively connecting the ring gear of the second planetary gear mechanism and the sun gear of the third planetary gear mechanism with the electrical continuously variable transmission unit; a second clutch selectively connecting the sun gears of the first and the second planetary gear mechanisms with the electrical continuously variable transmission unit; a first brake selectively fixing the sun gears of the first and the second planetary gear mechanisms; a second brake selectively fixing the carrier of the first planetary gear mechanism; and a third brake selectively fixing the ring gear of the third planetary gear mechanism.

In case the mechanical transmission unit comprises two sets of planetary gear mechanisms: sun gears of a first and a second planetary gear mechanisms are connected with each other; and a carrier of the first planetary gear mechanism and a ring gear of the second planetary gear mechanism are connected with each other, and those carrier and ring gear are connected with an output member. In this case, the mechanical transmission unit is provided with: a first clutch selectively connecting the ring gear of the first planetary gear mechanism with the electrical continuously variable transmission unit; a second clutch selectively connecting the sun gears of the first and the second planetary gear mechanisms with the electrical continuously variable transmission unit; a first brake selectively fixing the sun gears of the first and the second planetary gear mechanisms; and a second brake selectively fixing the carrier of the second planetary gear mechanism.

Further, according to the invention, the control system for an vehicle automatic transmission comprises a speed change control means for carrying out a normal speed change control of determining a speed change ratio on the basis of a running condition of a vehicle and of a speed change diagram in which the speed change ratio is set in accordance with the running condition of the vehicle, in case the failure is not detected by the failure detecting means.

Thus, according to the invention, in case a failure to set any of predetermined speed change ratios is detected, a speed change command for setting a speed change ratio larger than the current speed change ratio is outputted. Therefore, a large torque can be ensured in case the vehicle is run by the power outputted from the. On the other hand, a sufficient power source braking force can be established in case the vehicle is coasting.

In addition to the above advantage, in case of commanding to set a speed change ratio larger than the current speed change ratio, the speed change ratio is varied gradually. Therefore, a drive torque and a power source braking force are prevented from being changed abruptly. As a result, a behavior of the vehicle is stabilized so that passengers may not feel any uncomfortable feeling.

More specifically, in case of commanding to set a speed change ratio larger than the current speed change ratio, the speed change ratio is varied according to the vehicle speed. Therefore, a drive torque and a power source braking force are prevented from being changed abruptly. As a result, a behavior of the vehicle is stabilized so that passengers may not feel any uncomfortable feeling.

In addition to the above advantage, according to the invention, a total speed change ratio of the automatic transmission can be set or approximated to a target speed change ratio by changing a speed change ratio of one of the transmission units even if any of the electrical continuously variable transmission unit and the mechanical transmission unit have some kind of failure so that a desired speed change ratio cannot be set. Therefore, a drive force and a power source braking force can be ensured even if a failure occurs.

More specifically, the speed change ratio is controlled as explained above even if a failure occurs in the shifting mechanism for operating the transmission mechanism transmitting a torque. Therefore, a drive force and a power source braking force can be ensured.

In addition to the above advantage, in case a failure to set a predetermined deceleration is detected, a speed change command for setting a deceleration greater than the current deceleration is outputted. Therefore, a sufficient power source braking force can be established when the vehicle is coasting.

Moreover, in case of commanding to decelerate greater than the current deceleration, the deceleration is varied gradually. Therefore, a power source braking force is prevented from being changed abruptly. As a result, a behavior of the vehicle is stabilized so that passengers may not feel any uncomfortable feeling.

Further, in case of commanding to decelerate greater than the current deceleration, the deceleration is varied according to the vehicle speed. Therefore, a power source braking force is prevented from being changed abruptly. As a result, a behavior of the vehicle is stabilized so that passengers may not feel any uncomfortable feeling.

In addition, in case a failure occurs in the shifting mechanism for operating the transmission mechanism transmitting a torque, the deceleration is controlled as explained above. Therefore, sufficient power source braking force can be ensured.

In addition to the above advantage, the speed change ratio and the deceleration can be controlled by one of the transmission units even in case any of the electrical continuously variable transmission and the mechanical transmission has an aforementioned trouble. Therefore, a drive force and a power source braking force can be ensured.

In addition, according to the invention, a normal speed change control of determining a speed change ratio on the basis of a running condition of a vehicle and of a speed change diagram is carried out in case the failure is not detected.

### BRIEF DESCRIPTION OF THE DRAWINGS

FIG. 1 is a flowchart showing one example of the speed change control carried out by the control system of the invention.

FIG. 2 is a diagram schematically showing a relation between the target speed change ratio or target deceleration and the vehicle speed.

FIG. 3 is a time chart showing a case of carrying out a control of the control system of the invention when a failure in which a geared transmission is shifted upwardly occurs.

FIG. 4 is a skeleton diagram showing a drive unit of a hybrid vehicle to which the invention is applied.

FIG. 5 is a table showing gear stages set in the geared transmission unit and operating states of frictional engagement devices to set the gear stages.

FIG. 6 is a nomographic diagram explaining operating states of the transmission units shown in FIG. 4.

FIG. 7 is diagram showing an example of input signals and output signals of an electronic control unit.

FIG. 8 is a diagram schematically showing one example of a speed change diagram of the mechanical transmission unit.

FIG. 9 is a diagram showing one example of an arrangement of a shift position of a shifting device.

FIG. 10 is a skeleton diagram showing another example of a drive unit of a hybrid vehicle to which the invention is applied.

FIG. 11 is a table showing gear stages set in the geared transmission unit shown in FIG. 10 and operating states of the frictional engagement devices to set the gear stages.

FIG. 12 is a nomographic diagram explaining operating states of the transmission units shown in FIG. 10.

### BEST MODE FOR CARRYING OUT THE INVENTION

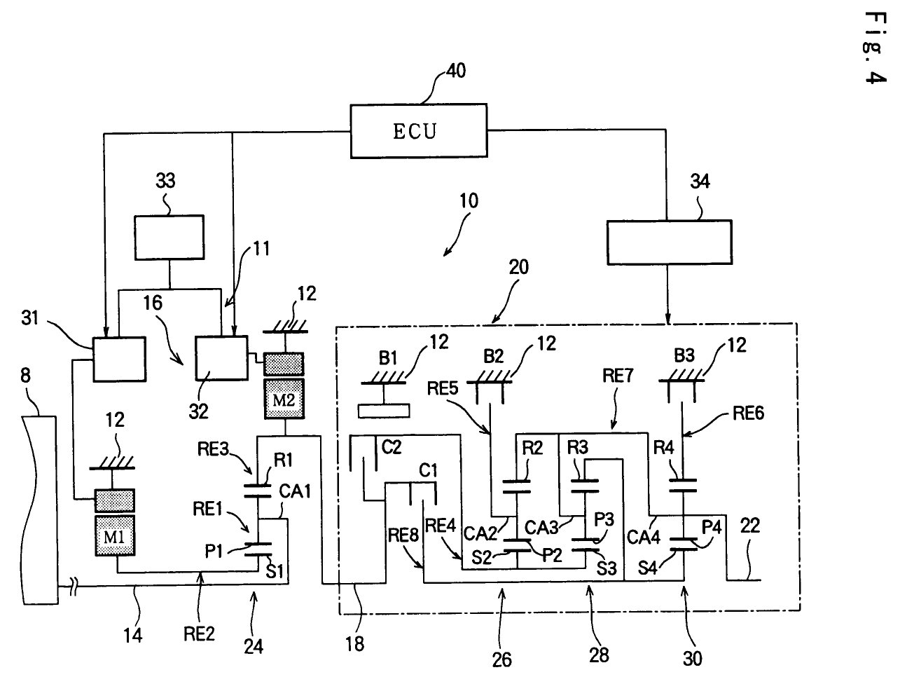

Next, this invention will be described in connection with its specific examples. A transmission 10 to which the invention is applied will be explained first of all. FIG. 4 is a skeleton diagram illustrating a transmission 10 for hybrid vehicles to which a control system as one example of the invention is applied. As illustrated in FIG. 4, the transmission 10 comprises, an input shaft 14 as an input rotary member arranged coaxially in a non-rotatable transmission case 12 (as will be called as a case 12 hereinafter) of a vehicle, an electrical continuously variable transmission unit 11 connected to the input shaft 14 directly or indirectly through a not shown pulsation absorbing damper (i.e., a vibration dampening device), a geared transmission unit 20 connected in tandem through a transmission member (i.e., a transmission shaft) 18 on a power transmission route between the continuously variable transmission unit 11 and a (not-shown) driving wheel, and an output shaft 22 as an output rotary member connected to the geared transmission unit 20. The above-listed elements are arranged in tandem in the transmission 10. This transmission 10 is suitable for front-engine rear-drive vehicles in which elements are arranged in tandem, and the transmission 10 is arranged between an engine as a prime mover for running and a pair of driving wheels 38. For example, a gasoline engine and a diesel engine or the like can be used as the engine 8 functioning as a prime mover. The engine 8 is connected to the input shaft 14 directly or indirectly through a not shown pulsation absorbing damper. Here, since the arrangement of the transmission 10 is symmetrical with respect to its axial line, a lower part thereof is omitted in the skeleton diagram of FIG. 4. The same applies to the following embodiments.

The continuously variable transmission unit 11 is a mechanism for mechanically distributing an output of the engine 8 inputted to a first electric motor M1 and to an input shaft 14. The continuously variable transmission unit 11 comprises a power distributing mechanism 16 functioning as a differential mechanism for distributing the output of the engine 8 to the first electric motor M1 and to the transmission member 18, and a second electric motor M2 arranged to rotate integrally with the transmission member 18. The second electric motor M2 may be arranged in any place on the power transmission route from the transmission member 18 to the driving wheel. According to this embodiment, both electric motors M1 and M2 are motor generators having a function to generate electric power. More specifically, the first electric motor M1 intrinsically has a function as a generator for establishing a reaction force, and the second electric motor M2 intrinsically has a function as a motor for outputting a driving force for running the vehicle.

The power distributing mechanism 16 is composed mainly of a single pinion type first planetary gear mechanism 24, and a gear ratio thereof is e.g., approximately “0.418” and it is represented by “ρ1”. The first planetary gear mechanism 24 comprises following rotary elements, such as a first sun gear S1, a first planetary gear P1, a first carrier CA1 holding the first planetary gear P1 in a rotatable and revolvable manner, and a first ring gear R1 meshing with the first sun gear S1 through the first planetary gear P1. The aforementioned gear ratio ρ1 is expressed as ZS1/ZR1. ZS1 represents a teeth number of the first sun gear S1, and ZR1 represents a teeth number of the first ring gear R1.

In the power distributing mechanism 16, the first carrier CA1 is connected to the input shaft 14, i.e., to the engine 8, the first sun gear S1 is connected to the first electric motor M1, and the first ring gear R1 is connected to the transmission member 18. A differential action of the power distributing mechanism 16 is achieved by allowing to rotate three elements of the first planetary gear mechanism 24, i.e., to rotate the first sun gear S1, the first carrier CA1 and the first ring gear R1 relatively among each other. As a result, the output of the engine 8 is distributed to the first electric motor M1 and to the transmission member 18, and the electric energy generated by the first electric motor M1 operated by a part of the output of the engine 8 is stored or drives the second electric motor M2. In consequence, the continuously variable transmission unit 11 (or the power distributing mechanism 16) functions as an electrical differential mechanism to achieve a “continuously variable transmission state (i.e., an electrical CVT state) where a differential ratio is varied continuously)”, so that the revolution frequency of the engine 8 is varied continuously without varying the revolution frequency of the transmission member 18. In short, when the power distributing mechanism 16 is performing the differential action, the continuously variable transmission unit 11 is also performing the differential action. Specifically, the continuously variable transmission unit 11 functions as an electrical continuously variable transmission, in which its speed change ratio Y0 (i.e., revolution frequency of the input shaft 14/revolution frequency of the transmission member 18) is varied continuously from a minimum value Y0 min to a maximum value Y0 max.

The geared transmission unit 20 comprises a single pinion type second planetary gear mechanism 26, a single pinion type third planetary gear mechanism 28 and a single pinion type fourth planetary gear mechanism 30. The second planetary gear mechanism 26 comprises a second sun gear S2, a second planetary gear P2, a second carrier CA2 holding the second planetary gear P2 in a rotatable and revolvable manner, and a second ring gear R2 meshing with the second sun gear S2 through the second planetary gear P2. The second planetary gear mechanism 26 has a predetermined gear ratio ρ2 which is approximately “0.562”. The third planetary gear mechanism 28 comprises a third sun gear S3, a third planetary gear P3, a third carrier CA3 holding the third planetary gear P3 in a rotatable and revolvable manner, and a third ring gear R3 meshing with the third sun gear S3 through the third planetary gear P3. The third planetary gear mechanism 28 has a predetermined gear ratio ρ3 which is approximately “0.425”. The fourth planetary gear mechanism 30 comprises a fourth sun gear S4, a fourth planetary gear P4, a fourth carrier CA4 holding the fourth planetary gear P4 in a rotatable and revolvable manner, and a fourth ring gear R4 meshing with the fourth sun gear S4 through the fourth planetary gear P4. The fourth planetary gear mechanism 30 has a predetermined gear ratio ρ4 which is approximately “0.421”. The aforementioned gear ratios ρ2 is expressed as ZS2/ZR2, ρ3 is expressed as ZS3/ZR3, and ρ4 is expressed as ZS4/ZR4. Here, ZS2 represents a teeth number of the second sun gear S2, ZR2 represents a teeth number of the second ring gear R2, ZS3 represents a teeth number of the third sun gear S3, ZR3 represents a teeth number of the third ring gear R3, ZS4 represents a teeth number of the fourth sun gear S4, and ZR4 represents a teeth number of the fourth ring gear R4.

Here will be explained a relation of connection in the geared transmission unit 20. The second sun gear S2 and the third sun gear S3 are connected integrally with each other. Those sun gears S2 and S3 are connected selectively to the transmission member 18 through the second clutch C2, and also connected selectively to the case 12 through a first brake B1. The second carrier CA2 is connected selectively to the case 12 through a second brake B2. The fourth ring gear R4 is connected selectively to the case 12 through a third brake B3. The second ring gear R2, the third carrier CA3 and the fourth carrier CA4 are connected integrally, and they are connected to the output shaft 22. The third ring gear R3 and the fourth sun gear S4 are connected integrally, and they are connected selectively to the transmission member 18 through the first clutch C1.

The aforementioned first clutch C1, second clutch C2, first brake B1, second brake B2 and third brake B3 are hydraulic frictional engagement devices generally used in conventional automatic transmissions for a vehicle. Those hydraulic frictional engagement devices are composed mainly of a wet multiple disc clutch in which a plurality of frictional discs facing with each other are pressed by a hydraulic actuator, a band brake in which one of the end of one or two band(s) applied to an outer circumferential face of a rotating drum is (are) wound up by a hydraulic actuator, and so on. The role of the hydraulic frictional engagement device is to connect the members of both sides thereof selectively.

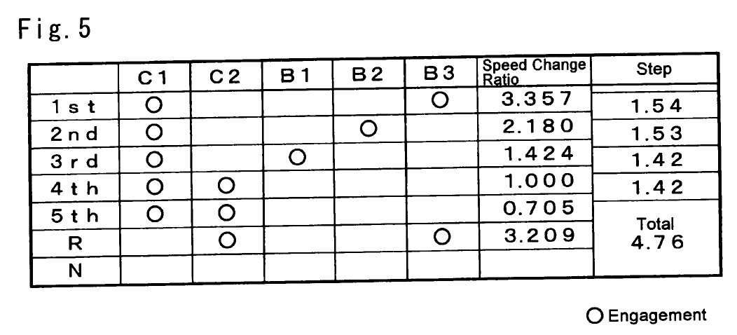

According to the transmission 10 thus far explained, as indicated in the table of FIG. 5, any of first gear stage (represented as 1st in the table) to a fifth gear stage (represented as 5th in the table), reverse gear stage (represented as R in the table), and neutral (represented as N in the table) are established by selectively activating the aforementioned elements, specifically, by selectively engaging the first clutch C1, the second clutch C2, the first brake B1, the second brake B2 and the third brake B3. As a result, a speed change ratio Y (i.e., input shaft speed NIN/output shaft speed NOUT), which changes substantially in equal ratio at every gear stage is obtained. It is to be especially noted that “the continuously variable transmission state” where the transmission 10 functions as an electrical continuously variable transmission is achieved by both of the continuously variable transmission unit 11 and the geared transmission unit 20.

Here will be explained engagement statuses of the case in which the transmission 10 functions as a geared transmission by fixing the speed change ratio of the continuously variable transmission unit 11. For example, as shown in FIG. 5: the first gear stage where the maximum value of a speed change ratio Y1 is approximately “3.357” is achieved by engaging the first clutch C1 and the third brake B3; the second gear stage where a speed change ratio Y2 is smaller than the speed change ratio of the first gear stage, e.g., approximately “2.180” is achieved by engaging the first clutch C1 and the second brake B2; the third gear stage where a speed change ratio Y3 is smaller than the speed change ratio of the second gear stage, e.g., approximately “1.424” is achieved by engaging the first clutch C1 and the first brake B1; the fourth gear stage where a speed change ratio Y4 is smaller than the speed change ratio of the third gear stage, e.g., approximately “1.000” is achieved by engaging the first clutch C1 and the second clutch C2; and the fifth gear stage where a speed change ratio Y5 is smaller than the speed change ratio of the fourth gear stage, e.g., approximately “0.705” is achieved by engaging the first clutch C1 and the second clutch C2. The reverse gear stage where a speed change ratio YR is between the speed change ratios of the first and the second gear stages, e.g., “3.209” is achieved by engaging the second clutch C2 and the third brake B3. Additionally, all of the frictional engagement devices are released to achieve Neutral.

Meanwhile, in case the transmission 10 functions as a continuously variable transmission, the continuously variable transmission unit 11 functions as a continuously variable transmission, and the geared transmission unit 20 arranged in tandem therewith functions as a geared transmission. As a result, the input revolution to the geared transmission unit 20, more specifically, the revolution frequency of the transmission member 18 to be inputted individually to the first to fourth gear stages of the geared transmission unit 20 is varied continuously, and the individual gear stages thereby obtaining a continuous range of the speed change ratio. For this reason, the speed change ratio can be varied steplessly and continuously even between the gear stages. Consequently, a speed change ratio YT achieved by the continuously variable transmission unit 11 and the geared transmission unit 20, more specifically, a total speed change ratio YT as an entire speed change ratio of the transmission 10, which is governed by both of the speed change ratio Y0 of the continuously variable transmission unit 11 and the speed change ratio Y of the geared transmission unit 20, can be varied steplessly.

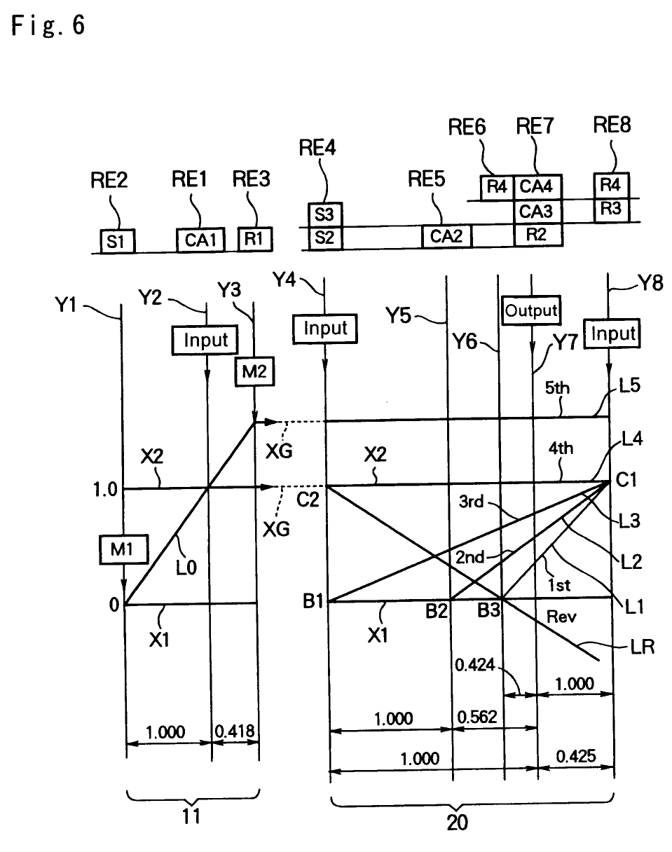

FIG. 6 is a nomographic diagram linearly indicating a relation of revolution frequencies of the rotary elements to be connected depending on the gear stage, in the transmission 10 comprising the continuously variable transmission unit 11 functioning as a differential unit or a first transmission unit, and the geared transmission unit 20 functioning as a (an automatic) transmission unit or a second transmission unit. The nomographic diagram of FIG. 6 is a two-dimensional coordinate composed of abscissa axes indicating relations of the gear ratios “ρ” of individual planetary gear mechanisms 24, 26, 28 and 30, and longitudinal axes indicating relative revolution frequencies. In the diagram, the bottom abscissa axis X1 represents “zero” revolution, and the middle abscissa axis X2 represents the revolution frequency of “1.0”, i.e., a revolution frequency Ne of the engine 8 connected with the input shaft 14, and an abscissa axis XG represents a revolution frequency of the transmission member 18.

Meanwhile, three longitudinal axes Y1, Y2 and Y3 individually indicates relative revolution frequencies of three elements of the power distribution mechanism 16 of the continuously variable transmission unit 11. Specifically, Y1 indicates relative revolution frequency of the first sun gear S1 corresponding to a second rotary element (or a second element) RE2, Y2 indicates relative revolution frequency of the first carrier CA1 corresponding to a first rotary element (or a first element) RE1, and Y3 indicates relative revolution frequency of the first ring gear R1 corresponding to a third rotary element (or a third element) RE3. Clearances between those longitudinal axes Y1 to Y3 are determined individually in accordance with a gear ratio ρ1 of the first planetary gear mechanism 24. Five longitudinal axes Y4 to Y8 individually represent the rotary elements of the geared transmission unit 20. Specifically, Y4 represents the mutually connected second sun gear S2 and third sun gear S3 corresponding to a fourth rotary element (or a fourth element) RE4, Y5 represents the second carrier CA2 corresponding to a fifth rotary element (or a fifth element) RE5, Y6 represents the fourth ring gear R4 corresponding to a sixth rotary element (or a sixth element) RE6, Y7 represents the mutually connected second ring gear R2, third carrier CA3 and fourth carrier CA4 corresponding to a seventh rotary element (or a seventh element) RE7, and Y8 represents the mutually connected third ring gear R3 and fourth sun gear S4 corresponding to an eighth rotary element (or a eighth element) RE8. Clearances between those longitudinal axes Y4 to Y8 are determined individually in accordance with a gear ratios ρ2, ρ3 and ρ4 of the second to fourth planetary gear mechanisms 26, 28 and 30. Provided that the clearance between the longitudinal axes representing the sun gear and the carrier is set to “1”, the clearance between the longitudinal axes representing the carrier and the ring gear indicates the gear ratio ρ of the planetary gear mechanism. Specifically, in the continuously variable transmission unit 11, the clearance between the longitudinal axes Y1 and Y2 is set to “1”, and the clearance between Y2 and Y3 is set to the gear ratio ρ1. In the second to fourth planetary gear mechanisms 26, 28 and 30 of the geared transmission unit 20, also, each clearance between the sun gear and the carrier is set to “1” and each clearance between the carrier and the ring gear is set to “ρ”.

As can be seen from the nomographic diagram in FIG. 6, in the power distribution mechanism 16 (or the continuously variable transmission unit 11) of the transmission 10 of this embodiment, the first rotary element RE1 (or the first carrier CA1) of the first planetary gear mechanism 24 is connected to the input shaft 14, i.e., to the engine 8, the second rotary element RE2 is connected to the first electric motor M1, and the third rotary element RE3 (or the first ring gear R1) is connected to the transmission member 18 and to the second electric motor M2. Therefore, a rotation of the input shaft 14 is transmitted (i.e., inputted) to the geared transmission unit 20 via the transmission member 18. The relation between the revolution frequencies of the first sun gear S1 and the first ring gear R1 is indicated by a slant line L0 passing through an intersection of Y2 with X2.

If the revolution frequency of the first sun gear S1 indicated at the intersection of the line L0 with the longitudinal axis Y1 is fluctuated by controlling the reaction force resulting from a generation of the first electric motor M1, the revolution frequency of the first ring gear R1 indicated at the intersection of the line L0 with the longitudinal axis Y3 is fluctuated.

On the other hand, in the geared transmission unit 20, the fourth rotary element RE4 is connected selectively to the transmission member 18 through the second clutch C2 and selectively to the case 12 through the first brake B1, the fifth rotary element RE5 is connected selectively to the case 12 through the second brake B2, the sixth rotary element RE6 is connected selectively to the case 12 through the third brake B3, the seventh rotary element RE7 is connected to the output shaft 22, and the eighth rotary element RE8 is connected selectively to the transmission member 18 through the first clutch C1.

As shown in FIG. 6, in the geared transmission unit 20, a revolution frequency of the output shaft 22 at the first gear stage is indicated at the intersection of the slant line L1 with the longitudinal axis Y7 indicating the revolution frequency of the seventh rotary element RE7 connected to the output shaft 22. Here, the line L1 is determined as a result of an engagement of the first clutch C1 and the third brake B3, and it extends from the intersection of the longitudinal axis Y6 indicating the revolution frequency of the sixth rotary element RE6 with the abscissa axis X1, to the intersection of the longitudinal axis Y8 indicating the revolution frequency of the eighth rotary element RE8 with the abscissa axis X2. As in the case of the first gear stage: a revolution frequency of the output shaft 22 at the second gear stage is indicated at the intersection of the longitudinal axis Y7 with a slant line L2 determined as a result of engaging the first clutch C1 and the second brake B2; a revolution frequency of the output shaft 22 at the third gear stage is indicated at the intersection of the longitudinal axis Y7 with a slant line L3 determined as a result of engaging the first clutch C1 and the first brake B1; and a revolution frequency of the output shaft 22 at the fourth gear stage is indicated at the intersection of the longitudinal axis Y7 with a horizontal line L4 determined as a result of engaging the first clutch C1 and the second clutch C2. At the aforementioned first to fourth gear stages, the power is inputted from the continuously variable transmission unit 11 or the power distribution mechanism 16 to the eighth rotary element RE8 at the revolution frequency identical to the revolution frequency Ne of the engine 8 by controlling the revolution frequency of the first electric motor M1. On the other hand, in case the first sun gear S1 is fixed by halting the rotation of the first electric motor M1, the power from the continuously variable transmission unit 11 is inputted at the revolution frequency higher than the revolution frequency NE of the engine 8. Therefore, a revolution frequency of the output shaft 22 at the fifth gear stage is indicated at the intersection of the longitudinal axis Y7 with a horizontal line L5 determined as a result of engaging the first clutch C1 and the second clutch C2.

In order to control the first electric motor M1, there is provided a first controller 31. Also, in order to control the second electric motor M2, there is provided a second controller 32. Those controllers 31 and 32 are composed mainly of an inverter, for example. The roles of those controllers 31 and 32 are to operate the individual electric motors M1 and M2 as electric motors or generators, and to control the revolution frequencies and the torques thereof depending on the situation. The electric motors M1 and M2 are individually connected with an electric storage device 33 through the controllers 31 and 32. The electric storage device 33 feeds electric power to the electric motors M1 and M2, and stores the electric power generated by the electric motors M1 and M2 in case those electric motors M1 and M2 function as generators. The electric storage device 33 is composed mainly of a secondary battery and a capacitor.

Also, in order to control engaging pressure and releasing pressure for the aforementioned clutches and brakes, there is provided a hydraulic control unit 34. The functions of the hydraulic control unit 34 are to regulate oil pressure established by an (not shown) oil pump to a line pressure, to control the engaging pressure of the individual frictional engagement devices based on the line pressure as an initial pressure, and to control the releasing pressure to release the frictional engagement devices. Specifically, known hydraulic control units used in automatic transmissions may be employed as the hydraulic control unit 34.

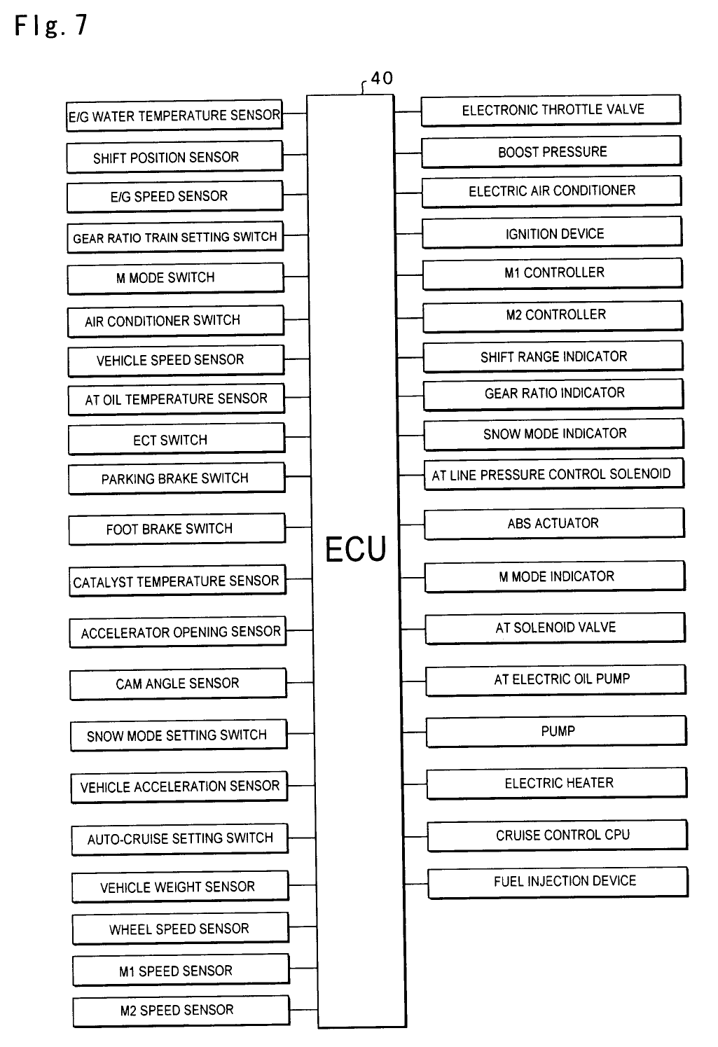

Further, there is provided an electronic control unit (ECU) 40 for controlling the transmission 10 entirely by controlling the aforementioned controllers 31 and 32, and the hydraulic control unit 34 by electronic signals. The signals inputted to the electronic control unit 40, and the signals outputted form the electronic control unit 40 are indicated in FIG. 7. The electronic control unit 40 comprises a microcomputer composed mainly of CPU, ROM, RAM and an input/output interface and so on. The electronic control unit 40 carries out drive controls, e.g., a hybrid drive control of the engine 8 and the first and the second electric motors M1 and M2, and a shift control of the geared transmission unit 20, by carrying out a signal process in accordance with a program stored in ROM in advance while utilizing a temporal storage function of RAM.

As shown in FIG. 7, a signal indicating a water temperature of the engine, a signal indicating a shift position, a signal indicating the revolution frequency Ne of the engine 8, a signal indicating the gear ratio train setting value, a signal instructing M mode (i.e., a motor running mode), a signal indicating an operation of an air-conditioner, a signal indicating a vehicle speed corresponding to the revolution frequency NOUT of the output shaft 22, a signal indicating an oil temperature of an operating oil (i.e., an AT oil temperature) of the geared transmission unit 20, a signal indicating an operation of a parking brake, a signal indicating an operation of a foot brake, a signal indicating a temperature of a catalyst, an accelerator opening signal indicating a stepping amount of the accelerator corresponding to an output demand of the driver, a cam angle signal, a signal indicating a snow mode setting, an acceleration signal indicating a longitudinal acceleration of the vehicle, a signal indicating an auto-cruise running, a signal indicating a weight of the vehicle, a signal indicating a speed of individual wheels, a signal indicating a revolution frequency of the first electric motor M1, a signal indicating a revolution frequency of the second electric motor M2 and so on, are inputted to the electronic control unit 40.

On the other hand, a driving signal to a throttle actuator for controlling an opening of an electronic throttle valve, a fuel feeding signal for controlling a feeding amount of the fuel from a fuel injection device to the engine 8, a boost regulating signal for regulating a boost pressure, a signal for activating the electric air-conditioner, an ignition signal for commanding a timing to ignite the engine 8 by an ignition device, a command signal for commanding an operation of the electric motors M1 and M2, a shift position (or an operating position) indicating signal for activating a shift indicator, a signal indicating a gear ratio, a signal indicating a snow mode, a signal for activating an ABS actuator for preventing a slippage of the wheel at a braking time, an M mode indication signal indicating that M mode is selected, a valve command signal for activating a solenoid valve of the hydraulic control unit 34 so as to control the hydraulic actuator of the hydraulic frictional engagement devices of the geared transmission unit 20, a drive command signal for activating an electric hydraulic pump as a hydraulic source of the hydraulic control unit 34, a signal for activating an electric heater, a signal to a computer for carrying out a cruise control and so on, are outputted from the electronic control unit 40.

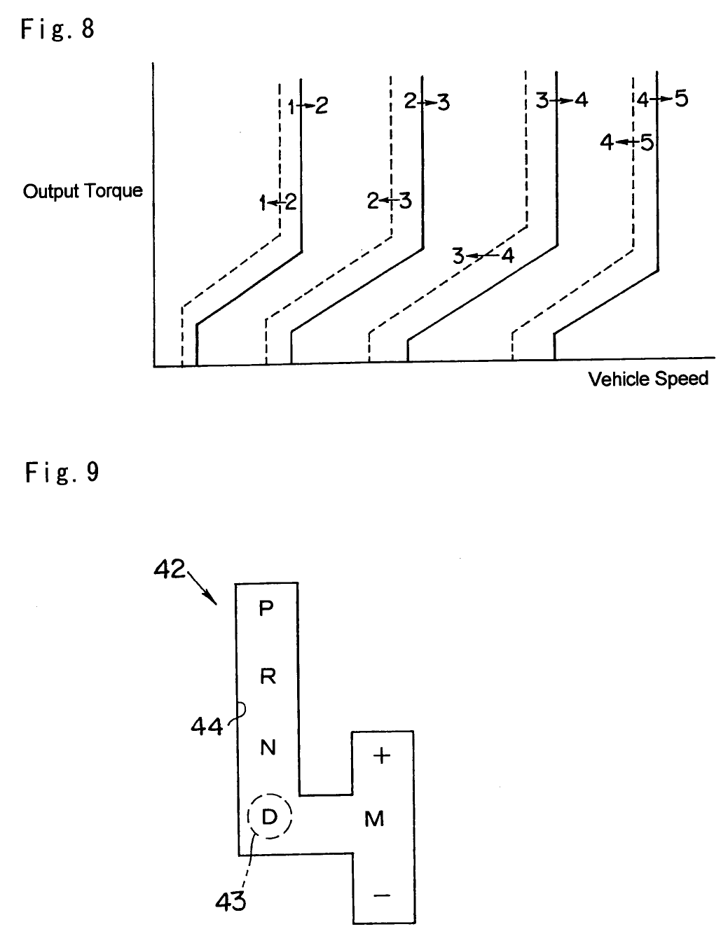

FIG. 8 shows a shifting diagram used for a shifting control of the geared transmission unit 20. In FIG. 8, an abscissa axis represents a vehicle speed and a longitudinal axis represents an output torque demand, and gear stage regions are defined using the vehicle speed and the output demand as parameters. Also, in FIG. 8, solid lines are upshift lines as boundaries of the individual gear stage regions for the case of upshifting, and broken lines are downshift lines as boundaries of the individual gear stage regions for the case of downshifting.

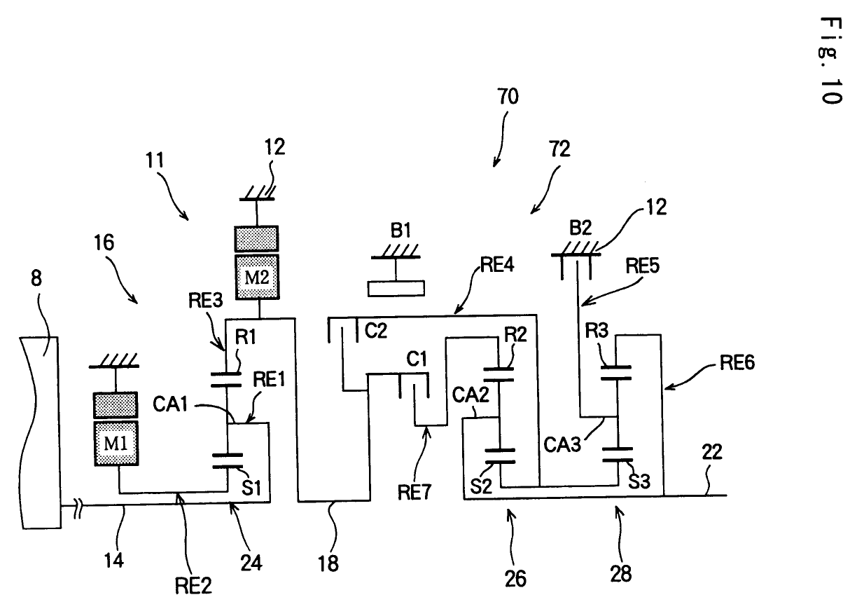

All of those gear stages can be established in case a Drive range (i.e., drive position) is selected, however, the gear stages of high speed side are restricted under a manual shifting mode (i.e., manual mode). FIG. 9 illustrates an arrangement of shift positions in a shifting device 42 for outputting a shift position signal to the aforementioned electronic control unit 40. In the shifting device 42, a Parking (P) for keeping the vehicle being stopped, a Reverse (R), a Neutral (N) and a Drive (D) positions are arranged linearly in an anteroposterior direction of the vehicle. A Manual position (M) is arranged adjacent to the Drive position (D) in the width direction of the vehicle, and an upshift position (+) and a downshift position (−) are arranged above and below the manual position. Those shift positions are connected through a guide groove 44 guiding a shift lever 43. Therefore, the shift position is selected arbitrary by moving the shift lever 43 along the guide groove 44, and the shift position signal of selected position is inputted to the electronic control unit 40.

In case the Drive position is selected, all of the forward stages of the geared transmission unit 20 from the first to fifth stages can be set depending on a running condition. On the other hand, in case the shift lever 43 is moved from the Drive position to the Manual position, the Drive position is maintained and a shifting can be made up to the fifth stage. However, in this case, a downshift signal (i.e., a down range signal) is outputted each time the shift lever 43 is moved to the downshift position. As a result, the gear stage is shifted sequentially to a 4th range where the fifth stage is inhibited, a 3rd range where the fourth or higher stages are inhibited, a 2nd range where the third or higher stages are inhibited, and an L range where the gear stage is fixed to the first stage. To the contrary, an upshift signal is outputted each time the shift lever 43 is moved to the upshift position, so that the gear stage is shifted sequentially to the higher range. Thus, the shifting device 42 corresponds to the shifting mechanism or the decelerating mechanism of the invention. On the other hand, the gear mechanism composed mainly of the planetary gear mechanisms 24, 26, 28 and 30 and the electric motors M1 and M2 shown in FIG. 4 corresponds to the transmission mechanism of the invention.

In order to drive the engine 8 at the revolution where the fuel economy is optimum while fulfilling a drive torque demand, and to drive the vehicle with good power transmission efficiency by reducing a conversion amount of the electric power, in the transmission 10, a gear stage of the geared transmission unit 20 is set according to the vehicle speed when the vehicle speed is within a predetermined range, and a speed change ratio of the continuously variable transmission unit 11 is varied continuously in this situation. Meanwhile, in case the running condition across the gear stage regions shown in the shifting diagram of FIG. 8, the geared transmission unit 20 is shifted in line with the shifting diagram. Specifically, the frictional engagement devices are engaged and released according to the gear stages listed in FIG. 5. The gear stage of the geared transmission unit 20 is thus shifted stepwise. Therefore, in order to prevent or minimize a change in the engine revolution, the speed change ratio of the continuously variable transmission unit 11 is varied in the direction opposite to the changing direction of the speed change ratio of the geared transmission unit 20. For example, in case of carrying out a downshifting of the geared transmission unit 20, revolution frequencies of the eighth rotary element RE8 (i.e., the third ring gear R3 and fourth sun gear S4) as an input element shown in FIG. 4 are raised by an increase in the speed change ratio of the geared transmission unit 20. As a result, a revolution frequency of the first ring gear R1 connected with the eighth rotary element RE8 through the first clutch C1, as well as a revolution frequency of the first electric motor M1 are raised. This control is carried out to raise the revolution frequency of the first ring gear R1 to keep the engine revolution as much as possible. For this purpose, the engine revolution is lowered relatively, and an upshifting of the continuously variable transmission unit 11 is carried out.

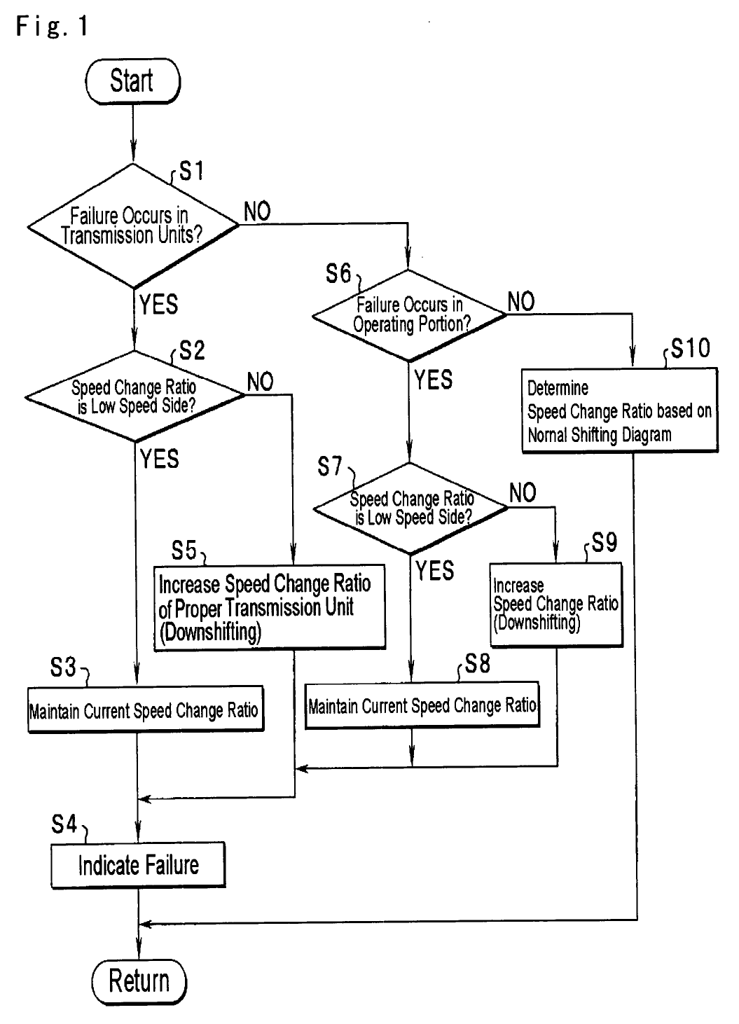

The control system of the present invention is adapted to carry out the control to be explained in the following, in case some kind of failure occurs in a control of a speed change ratio or a deceleration of the transmission 10. FIG. 1 is a flowchart explaining one example of the control. In this example, first of all, it is judged whether or not a failure occurs in the transmission units 11 and 20 (at Step S1). A definition of the “failure” is a state where a control of a speed change ratio is disrupted. For example, as to the continuously variable transmission unit 11, a malfunction of the revolution sensor of the first electric motor M1 shall be deemed as the “failure”. On the other hand, as to the geared transmission unit 20, a malfunction of a shift solenoid valve switching an oil pressure for carrying out a shifting operation shall be deemed as the “failure”.

In case some sort of failure in the transmission units 11 and 20 is detected so that the answer of Step S1 is YES, it is judged whether or not a current speed change ratio is a speed change ratio of a low speed side (at Step S2). Here, a definition of the speed change ratio of the “low speed side” is a predetermined speed change ratio by which sufficient drive torque to climb an upslope expected on a normal road can be obtained, and by which sufficient power source braking force (i.e., an engine braking force) to decelerate the vehicle 1 can be obtained. As explained above, the transmission 10 functions as a continuously variable transmission, the speed change ratio of the low speed side may be set to a value larger than a predetermined value.

In case the current speed change ratio is the speed change ratio of the low speed side so that the answer of Step S2 is YES, the current speed change ratio is maintained (at Step S3). This is because sufficient drive force and power source braking force can be obtained. Then, contents (or states) of the failure is indicated in an (not shown) instrument panel or the like (at Step S4). In this case, the actual speed change ratio and deceleration may be indicated together.

To the contrary, in case the current speed change ratio is not the speed change ratio of the low speed side so that the answer of Step S2 is NO, a downshifting is carried out to set a (total) speed change ratio larger than the current speed change ratio by increasing the speed change ratio of the transmission unit functioning properly (at Step S5). Then, the routine advances to Step S4 to indicate the failure.

As explained above, the transmission 10 comprises two transmission units capable of setting speed change ratios thereof independently such as the continuously variable transmission unit 11 and the geared transmission unit 20. In this case, it is not very often that the failures occur in both of the transmission units 11 and 20 simultaneously. That is, the failure normally occurs in one of the transmission units 11 and 20. This means that the speed change ratio of one of the transmission units 11 and 20 may be controlled even in case the failure is judged at Step S1. Therefore, at Step S5, a downshifting of one of the controllable transmission units 11 and 20 is carried out to increase the entire (i.e., a total) speed change ratio of the transmission 10, thereby obtaining a sufficient power source braking force (i.e., a deceleration) and a drive torque to drive the vehicle.

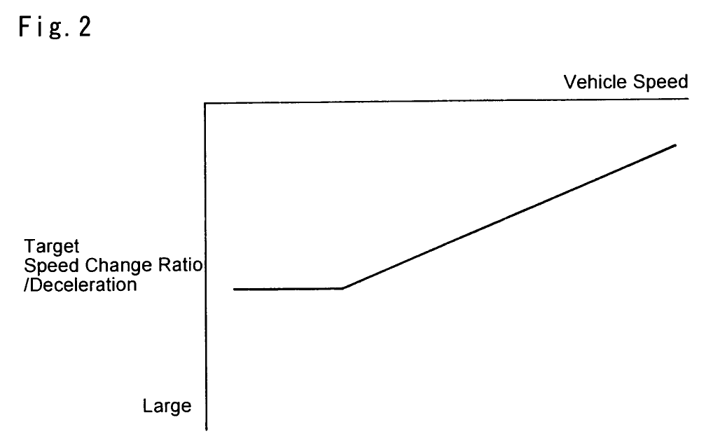

A target speed change ratio to be achieved as a result of the downshifting corresponds to the current vehicle speed. This is schematically shown in FIG. 2. As can be seen from FIG. 2, the target speed change ratio is reduced (to a high sped side) with an increase in the vehicle speed thereby stabilizing a behavior of the vehicle 1 by restraining a variation in the power source braking force and the drive force. As mentioned above, FIG. 2 shows the example in which the target speed change ratio is set in accordance only with the vehicle speed. However, a condition in that the foot brake is operated, and a condition in that the vehicle is towing a house trailer may be added to set the target speed change ratio. In case any of said additional conditions is satisfied, the speed change ratio may be set to a ratio larger than the target speed change ratio shown in FIG. 2. Additionally, it is preferable to approximate the target speed change ratio to the speed change ratio to be set under the condition where no failures occur.

On the other hand, in case no failures occur in the transmission units 11 and 20 so that the answer of Step S1 is NO, it is judged whether or not a failure occurs in an operating portion (at Step S6). Here, the operating portion includes the shifting device 42, a (not shown) switch for controlling a regenerative torque of the second electric motor M2 and so on. For example, an occurrence of a failure in which a speed change command, especially a downshift command cannot be outputted from the shifting device 42, and a failure in which a command for raising the regenerative torque cannot be outputted, are judged at Step S6. Specifically, a breakdown of the (not shown) switches of the shift positions, a contact failure, a braking of wire and so on are judged at Step S6.

In case the answer of Step S6 is YES, it is judged whether or not the current speed change ratio is the predetermined low speed side speed change ratio (at Step S7). The judgment at Step S7 is identical to the judgment at Step S2. That is, in case the answer of Step S7 is YES, sufficient power source braking force can be obtained, and sufficient drive torque can also be obtained when accelerating the vehicle. Therefore, the current speed change ratio is maintained (at Step S8). Then, the routine advances to Step S4 to indicate the failure. To the contrary, in case the current speed change ratio is not the speed change ratio of the low speed side so that the answer of Step S7 is NO, the (total) speed change ratio is increased (at Step S9). Specifically, a downshifting is carried out. Then, the routine advances to Step S4 to indicate the failure.

In this case, since no failure occurs in the transmission mechanism setting a speed change ratio such as the continuously variable transmission unit 11 and the geared transmission unit 20, the total speed change ratio is increased by controlling the transmission units 11 and 20. In this case, the target speed change ratio is set according to the vehicle speed, as in the case of step S5.

In case an occurrence of a failure in the operating portion is not detected so that the answer of Step S6 is NO, this means that no failure occurs in any of the transmission units. Therefore, a normal speed change control is carried out (at Step S10). Here, the normal speed change control is a control for determining a speed change ratio based on the running condition of the vehicle 1 such as an output torque demand and a vehicle speed and on the shifting diagram of FIG. 8, and achieving the determined speed change ratio.

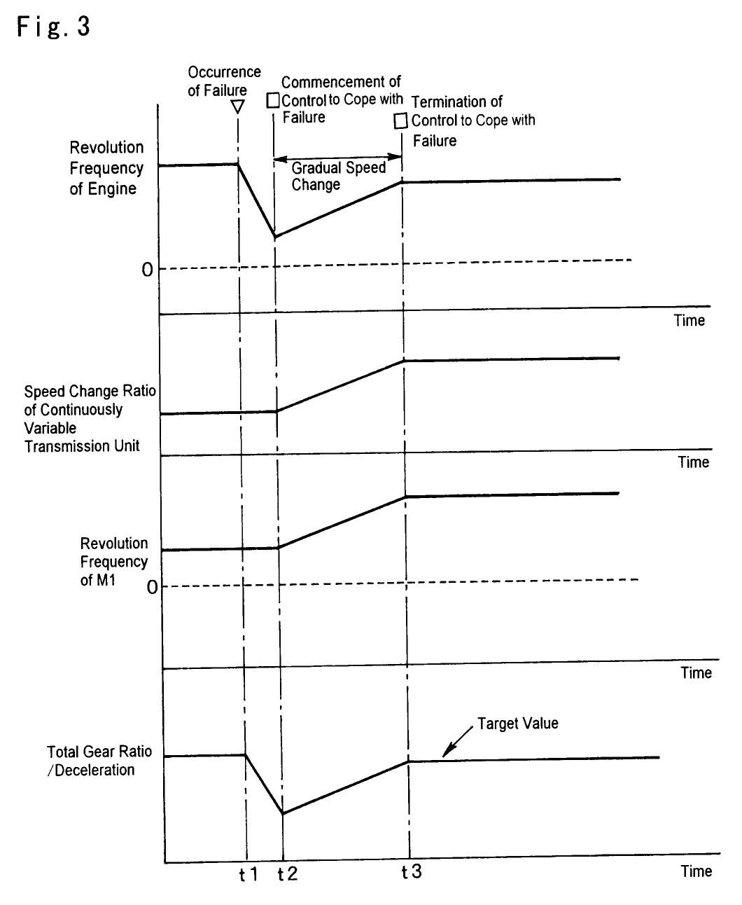

FIG. 3 shows one example of a time chart of the case in which the above-explained control is carried out when the failure occurs. The time chart of FIG. 3 shows a case in which a failure occurs in the geared transmission unit 20 and the speed change ratio of the geared transmission unit 20 is thereby reduced when the vehicle 1 is running. When the failure occurs at the time t1, the total speed change ratio is reduced due to the reduction in the speed change ratio of the geared transmission unit 20 (i.e., an upshifting). As a result, a revolution frequency of the engine 8 drops so that the drive torque is reduced. Then, a control to cope with the failure is started at the time t2. Specifically, a downshifting to vary a speed change ratio of the continuously variable transmission unit 11 functioning properly is started in the direction opposite to the direction of the upshifting of the geared transmission unit 20 resulting from the failure. That is, this control is carried out to increase the speed change ratio of the continuously variable transmission unit 11 by raising a revolution frequency of the first electric motor M1.

As explained above, in the control to cope with the failure, the target speed change ratio is set according to the current vehicle speed, and set at least larger than the speed change ratio at the starting time of the control to cope with the failure. Here, this speed change to the target speed change ratio is not induced artificially, in other words, this speed change to the target speed change ratio is not caused by operating the accelerator pedal or the shifting device 42 to accelerate or decelerate the vehicle. Therefore, in order to moderate a variation in the drive torque resulting from the speed change, the speed change ratio is not changed to the target speed change ratio immediately but changed with a predetermined gradient, i.e., with a predetermined rate of change. That is, the speed change ratio is varied gradually to the target speed change ratio. The rate of change may be determined in advance taking into consideration the changes in the drive torque and the behavior of the vehicle. Alternatively, the rate of change may be determined by setting an allowable time for the control to cope with the failure in advance (between the times t2 and t3), and by calculating from a length of the allowable time and a variation width of the speed change ratio during the allowable time. The drive torque and a behavior of the vehicle can be prevented from being changed abruptly by thus varying the speed change ratio gradually. As a result, passengers will not feel any uncomfortable feeling.

If the control system of the present invention thus carries out the above-explained control, the speed change ratio is increased as a result of an occurrence of the failure in the transmission 10. For this reason, sufficient power source braking force can be established when the vehicle is coasting. In addition, the drive torque is increased as a result of increasing the total speed change ratio. Therefore, the vehicle is allowed to perform a retreating running in case of continuing to run the vehicle even after the occurrence of the failure.

According to the hybrid drive unit illustrated in FIG. 4, a kinetic energy of the vehicle resulting from a deceleration is regenerated to be an electric energy, and a reaction force resulting from such regeneration acts as a braking force to decelerate the vehicle. This means that if the regeneration cannot be carried out properly due to a failure in any of the electric motors M1 and M2, a control system thereof and an electrical system thereof, a target deceleration cannot be achieved. This kind of deceleration with regeneration of energy is carried out not only by a change in the running condition in which the output torque demand is eliminated when the vehicle is running at the speed higher than a predetermined speed, but also by moving the shift lever 43 to the downshift position. That is, the target deceleration cannot be achieved also in case the failure occurs in the operating mechanism such as the shifting device 42 or the like.

The system of the invention can carry out the control to increase a deceleration by raising a power source braking as the control example shown in FIG. 1, even in case a failure occurs in the mechanism or device to set the deceleration. The control of this case will be explained hereinafter with reference to FIG. 1. In this case, a failure in the electric motors M1 and M2, a control system thereof and an electrical system thereof is judged at Step S1 instead of judging the failure in the transmission unit. The judgments of the low speed side speed change ratio at Steps S2 and S7 may be carried out as it is. Alternatively, at Steps S2 and S7, a judgment of a current deceleration may be carried out together with the judgment of the low speed side speed change ratio, or carried out instead of the judgment of the low speed side speed change ratio. The processes of Steps S3 and S8 for maintaining the current speed change ratio may be carried out as it is. Alternatively, at Steps S3 and S8, the deceleration is maintained together with maintaining the speed change ratio, or instead of maintaining the speed change ratio. Also, the processes of Steps S5 and S9 for increasing the speed change ratio may be carried out as it is. Alternatively, at Steps S5 and S9, the deceleration is increased together with increasing the speed change ratio, or instead of increasing the speed change ratio. In this case, a target deceleration is set at Steps S5 and S9 to be reduced with an increase in the vehicle speed as shown in FIG. 2. Additionally, it is preferable to approximate the target deceleration to the deceleration to be set under the condition where no failures occur. Further, the target deceleration may be increased relatively when the foot brake is operated and when the vehicle is towing a house trailer, as the case of aforementioned target speed change ratio.

Thus, the functional means of Step S1 corresponds to the failure detecting means of the invention, and the functional means of Step S5 or S9 corresponds to the speed change commanding means of the invention.

A transmission to which the present invention is applied should not be limited to the transmission shown in FIG. 4. Specifically, the present invention may also be applied to a transmission comprising a geared transmission capable of setting four forward stages. An example is shown in FIGS. 10 to 12.

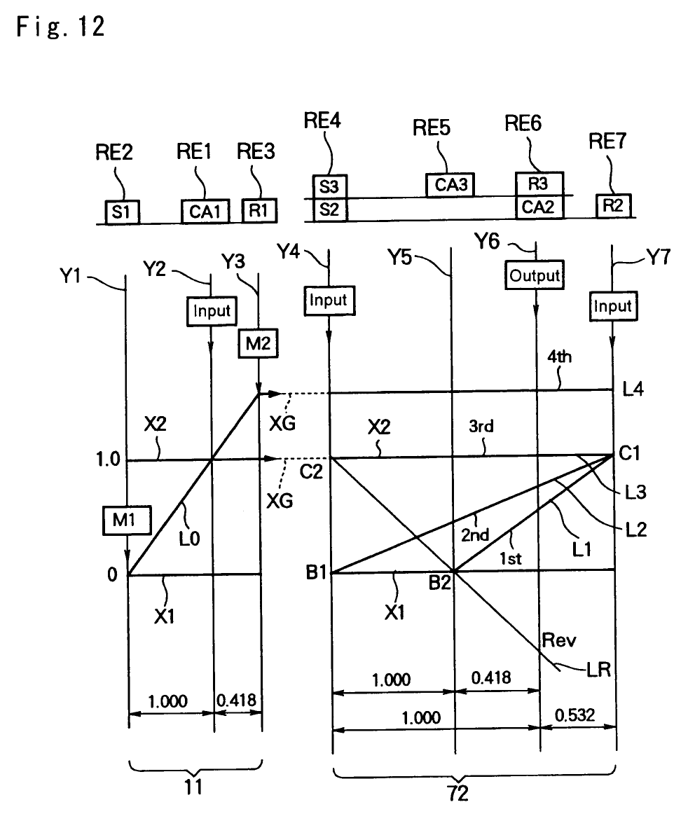

As the aforementioned example, the transmission 70 shown in FIG. 12 comprises: a continuously variable transmission unit 11 having a first electric motor M1, a power distribution mechanism 16, and a second electric motor M2; and a geared transmission unit 72 capable of setting three forward stages, which is connected in tandem through a transmission member 18 between the continuously variable transmission unit 11 and an output shaft 22. The power distributing mechanism 16 comprises a single pinion type first planetary gear mechanism 24 the gear ratio thereof is e.g., approximately “0.418”, and it is represented by “ρ1”. The geared transmission unit 72 comprises: a single pinion type second planetary gear mechanism 26 the gear ratio thereof is e.g., approximately “0.532”, and it is represented by “ρ2”; and a single pinion type third planetary gear mechanism 28 the gear ratio thereof is e.g., approximately “0.418”, and it is represented by “ρ3”. A second sun gear S2 of the second planetary gear mechanism 26 and a third sun gear S3 of the third planetary gear mechanism 28 are connected integrally with each other. Those sun gears S2 and S3 are connected selectively to the transmission member 18 through a second clutch C2, and also connected selectively to a case 12 through a first brake B1. A second carrier CA2 of the second planetary gear mechanism 26 and a third ring gear R3 of the third planetary gear mechanism 28 are connected integrally with each other. Those carrier CA2 and ring gear R3 are connected to the output shaft 22. A second ring gear R2 of the second planetary gear mechanism 26 is connected selectively to the transmission member 18 through a first clutch C1, and a third carrier CA3 of the third planetary gear mechanism 28 is connected selectively to the case 12 through a second brake B2.

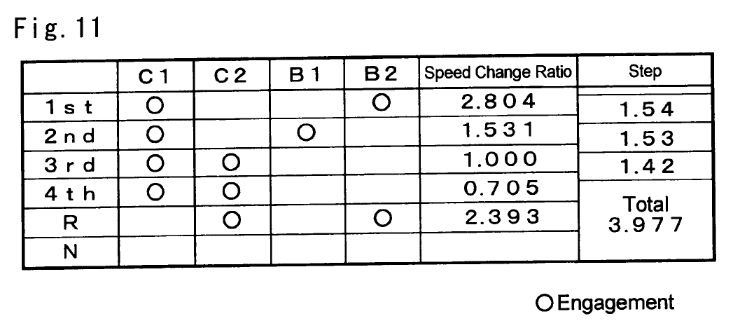

According to the transmission 70 thus far explained, as indicated in the table of FIG. 11, a first gear stage (represented as 1st in the table) to a fourth gear stage (represented as 4th in the table), a reverse gear stage (represented as R in the table), and a neutral (represented as N in the table) are achieved by selectively activating the aforementioned elements, specifically, by selectively engaging the first clutch C1, the second clutch C2, the first brake B1, and the second brake B2. As a result, a speed change ratio Y (i.e., input shaft revolution NIN/output shaft revolution NOUT), which changes substantially in equal ratio at every gear stage is obtained.

For example, if the speed change ratio of the continuously variable transmission unit 11 is kept constant, the transmission 70 functions as a geared transmission. As shown in FIG. 11: the first gear stage where the maximum value of a speed change ratio Y1 is approximately “2.804” is achieved by engaging the first clutch C1 and the second brake B2; the second gear stage where a speed change ratio Y2 is smaller than the speed change ratio of the first gear stage, e.g., approximately “1.531” is achieved by engaging the first clutch C1 and the first brake B1; the third gear stage where a speed change ratio Y3 is smaller than the speed change ratio of the second gear stage, e.g., approximately “1.000” is achieved by engaging the first clutch C1 and the second clutch C2; and the fourth gear stage where a speed change ratio Y4 is smaller than the speed change ratio of the third gear stage, e.g., approximately “0.705” is achieved by engaging the first clutch C1 and the second clutch C2. The Reverse gear stage where a speed change ratio YR is between the speed change ratios of the first and the second gear stages, e.g., “2.393” is achieved by engaging the second clutch C2 and the second brake B2. Additionally, all of the frictional engagement devices are released to achieve Neutral.

Meanwhile, in case the transmission 70 functions as a continuously variable transmission, the continuously variable transmission unit 11 functions as a continuously variable transmission, and the geared transmission unit 72 arranged in tandem therewith functions as a geared transmission. As a result, the input revolution to the geared transmission unit 72, more specifically, the revolution frequency of the transmission member 18 to be inputted individually to the first to third gear stages of the geared transmission unit 72 is varied continuously, and the individual gear stages thereby obtaining a continuous range of the speed change ratio. For this reason, the speed change ratio can be varied steplessly and continuously even between the gear stages. Consequently, a total speed change ratio YT as an entire speed change ratio of the transmission 70 can be varied steplessly.

FIG. 12 is a nomographic diagram linearly indicating a relation of revolution frequencies of the rotary elements to be connected depending on the gear stages, in the transmission 70 comprising the continuously variable transmission unit 11 functioning as a differential unit or a first transmission unit, and the geared transmission unit 72 functioning as a (an automatic) transmission unit or a second transmission unit.

In FIG. 12, four longitudinal axes Y4, Y5, Y6 and Y7 individually represents the rotary elements of the automatic transmission 72. Specifically, Y4 represents the mutually connected second sun gear S2 and third sun gear S3 corresponding to a fourth rotary element (or a fourth element) RE4, Y5 represents the third carrier CA3 corresponding to a fifth rotary element (or a fifth element) RE5, Y6 represents the mutually connected second carrier CA2 and third ring gear R3 corresponding to a sixth rotary element (or a sixth element) RE6, and Y7 represents the second ring gear R2 corresponding to a seventh rotary element (or a seventh element) RE7. In the geared transmission unit 72, the fourth rotary element RE4 is connected selectively to the transmission member 18 through the second clutch C2 and selectively to the case 12 through the first brake B1, the fifth rotary element RE5 is connected selectively to the case 12 through the second brake B2, the sixth rotary element RE6 is connected selectively to the output shaft 22 of the automatic transmission 72, and the seventh rotary element RE7 is connected selectively to the transmission member 18 through the first clutch C1.

As shown in FIG. 12, in the geared transmission unit 72, a revolution frequency of the output shaft 22 at the first gear stage is indicated at the intersection of the slant line L1 with the longitudinal axis Y6 indicating the revolution frequency of the sixth rotary element RE6 (CA2, R3) connected to the output shaft 22. Here, the line L1 is determined as a result of an engagement of the first clutch C1 and the second brake B2, and it extends from the intersection of the longitudinal axis Y7 indicating the revolution frequency of the seventh rotary element RE7 (R2) with the abscissa axis X2, to the intersection of the longitudinal axis Y5 indicating the revolution frequency of the fifth rotary element RE5 (CA3) with the abscissa axis X1. As in the case of the first gear stage: a revolution frequency of the output shaft 22 at the second gear stage is indicated at the intersection of the longitudinal axis Y6 with a slant line L2 determined as a result of engaging the first clutch C1 and the first brake B1; and a revolution frequency of the output shaft 22 at the third gear stage is indicated at the intersection of the longitudinal axis Y6 with a horizontal line L3 determined as a result of engaging the first clutch C1 and the second clutch C2. At the aforementioned first to third gear stages, the power is inputted from the continuously variable transmission unit 11 to the seventh rotary element RE7 at the revolution frequency identical to the revolution frequency Ne of the engine 8. Meanwhile, in case the first planetary gear mechanism 24 is used as a speed increasing mechanism by halting the rotation of the first sun gear S1 by the first electric motor M1, the power from the continuously variable transmission unit 11 is inputted at the revolution frequency higher than the revolution frequency NE of the engine 8. Therefore, a revolution frequency of the output shaft 22 at the fourth gear stage is indicated at the intersection of the longitudinal axis Y6 with a horizontal line L4 determined as a result of engaging the first clutch C1 and the second clutch C2.

The transmission 70 also comprises the continuously variable transmission unit 11 functioning as a differential mechanism or a first transmission unit, and the geared transmission unit 72 functioning as an automatic speed change unit or a second transmission unit. Accordingly, the advantages explained in the aforementioned example can be achieved also by this example.

Here, according to the invention, the planetary gear mechanism constituting the continuously variable transmission unit may also be a double pinion type other than the single pinion type. Further, it is also possible to provide a clutch for integrating the planetary gear mechanisms, and a brake for operating the planetary gear mechanism as a speed increasing mechanism. Furthermore, according to the invention, either the continuously variable transmission unit and the geared transmission unit may be arranged on the engine side. Additionally, the automatic transmission of the invention may be a transmission composed of a single geared transmission, or a single continuously variable transmission.

### INDUSTRIAL APPLICABILITY

The present invention can be utilized in a field of manufacturing and repairing automobiles such as cars, and in a field of manufacturing and processing parts for automobiles.

1. A control system for an automatic transmission of vehicle, comprising:
a failure detecting means for detecting a failure to set any of predetermined speed change ratios; and
a speed change commanding means for outputting a speed change command to set a speed change ratio larger than the current speed change ratio in accordance with a signal outputted when the failure detecting means detects the failure.

2. The control system for an automatic transmission of vehicle as claimed in claim 1, wherein:
the speed change commanding means includes a means for commanding to vary the speed change ratio gradually in case of commanding to set the speed change ratio larger than the current speed change ratio.

3. The control system for an automatic transmission of vehicle as claimed in claim 1, wherein:
the speed change commanding means includes a means for commanding to set a speed change ratio according to the vehicle speed, in case of commanding to set the speed change ratio larger than the current speed change ratio.

4. The control system for an automatic transmission of vehicle as claimed in claim 1, wherein:
the automatic transmission comprises at least two transmission units capable of setting a speed change ratio individually; and
the speed change commanding means includes a means outputting a speed change command for increasing a speed change ratio of one of the transmission units in case the failure detecting means detects a failure in any of the transmission units.

5. The control system for an automatic transmission of vehicle as claimed in claim 1, wherein:
the automatic transmission comprises a transmission mechanism for transmitting a power, and a shifting mechanism for a shifting operation of a speed change ratio achieved by the transmission mechanism; and
the failure detecting means includes a means for detecting a failure in the shifting mechanism.

6. The control system for an automatic transmission of vehicle as claimed in claim 5, wherein:
the speed change commanding means includes a means outputting a speed change command for varying speed change ratios of the transmission units in case the failure detecting means detects a failure in the shifting mechanism.

7. A control system for an automatic transmission of vehicle capable of controlling a deceleration of a vehicle by varying a negative torque opposite to a torque for running the vehicle, comprising:
a failure detecting means for detecting a failure to set any of predetermined decelerations; and
a speed change commanding means for outputting a deceleration command to set a deceleration greater than the current deceleration in accordance with a signal outputted when the failure detecting means detects the failure.

8. The control system for an automatic transmission of vehicle as claimed in claim 7, wherein:
the speed change commanding means includes a means for commanding to vary the deceleration gradually, in case of commanding to set the deceleration greater than the current deceleration.

9. The control system for an automatic transmission of vehicle as claimed in claim 7, wherein:
the speed change commanding means includes a means for commanding to set the deceleration according to the vehicle speed, in case of commanding to set the deceleration greater than the current deceleration.

10. The control system for an automatic transmission of vehicle as claimed in claim 7, wherein:
the automatic transmission comprises a transmission mechanism for transmitting a power, and a decelerating mechanism for a changing operation of the deceleration by varying a torque transmitted through the transmission mechanism; and
the failure detecting means includes a means for detecting a failure in the decelerating mechanism.

11. The control system for an automatic transmission of vehicle as claimed in claim 1, wherein:
the automatic transmission comprises an electrical continuously variable transmission unit in which a speed change ratio thereof is controlled electrically and varied continuously, and a mechanical transmission unit in which a speed change ratio thereof is changed by changing a torque transmitting point.

12. The control system for an automatic transmission of vehicle as claimed in claim 11, wherein:
the electrical continuously variable transmission unit and mechanical transmission unit are connected in tandem so as to input power outputted from any one of those transmissions to the other one.

13. The control system for an automatic transmission of vehicle as claimed in claim 11, wherein:
a speed change ratio of the automatic transmission is set by both of the electrical continuously variable transmission unit and mechanical transmission unit.

14. The control system for an automatic transmission of vehicle as claimed in claim 11, wherein:
the electrical continuously variable transmission unit is composed mainly of a differential gear mechanism having: an input rotary element connected with an internal combustion engine; a reaction rotary element connected with an electric motor in which a torque and a revolution frequency thereof are controlled electrically; and an output rotary element connected with the mechanical transmission unit.

15. The control system for an automatic transmission of vehicle as claimed in claim 14, wherein:
the differential gear mechanism includes a single pinion type planetary gear mechanism having a carrier functioning as an input rotary element, a sun gear functioning as the reaction rotary element, and a ring gear functioning as the output rotary element.

16. The control system for an automatic transmission of vehicle as claimed in claim 11, wherein:
the mechanical transmission unit is constructed of three sets of planetary gear mechanisms and a plurality of engagement devices.

17. The control system for an automatic transmission of vehicle as claimed in claim 16, wherein:
the planetary gear mechanism includes a single pinion type planetary gear mechanism; sun gears of first and second planetary gear mechanisms are connected with each other; a ring gear of the first planetary gear mechanism, a carrier of the second planetary gear mechanism and a carrier of the third planetary gear mechanism are connected and those ring gear and carriers are connected with an output member; and a ring gear of the second planetary gear mechanism and a sun gear of the third planetary gear mechanism are connected with each other; and
the engagement device includes: a first clutch connecting the ring gear of the second planetary gear mechanism and the sun gear of the third planetary gear mechanism with the electrical continuously variable transmission unit selectively; a second clutch connecting the sun gears of the first and second planetary gear mechanisms with the electrical continuously variable transmission unit selectively; a first brake fixing the sun gears of the first and second planetary gear mechanisms selectively; a second brake fixing the carrier of the first planetary gear mechanism selectively; and a third brake fixing the ring gear of the third planetary gear mechanism selectively.

18. The control system for an automatic transmission of vehicle as claimed in claim 11, wherein:
the mechanical transmission unit is constructed of two sets of planetary gear mechanisms and a plurality of engagement devices.

19. The control system for an automatic transmission of vehicle as claimed in claim 18, wherein:
the planetary gear mechanism includes a single pinion type planetary gear mechanism; sun gears of first and second planetary gear mechanisms are connected with each other; and a carrier of the first planetary gear mechanism and a ring gear of the second planetary gear mechanism are connected and those carrier and the ring gear are connected with an output member; and
the engagement device includes: a first clutch connecting the ring gear of the first planetary gear mechanism with the electrical continuously variable transmission unit selectively; a second clutch connecting the sun gears of the first and second planetary gear mechanisms with the electrical continuously variable transmission unit selectively; a first brake fixing the sun gears of the first and second planetary gear mechanisms selectively; and a second brake fixing the carrier of the second planetary gear mechanism selectively.

20. The control system for an automatic transmission of vehicle as claimed in claim 1, further comprising:
a speed change control means for carrying out a normal speed change control for determining a speed change ratio on the basis of a running condition of the vehicle and of a speed change diagram in which the speed change ratio is set in accordance with the running condition of the vehicle, in case the failure is not detected by the failure detecting means.

21. The control system for an automatic transmission of vehicle as claimed in claim 5, wherein:
the shifting mechanism comprises a means for outputting an upshift signal or a downshift signal when operated manually.

22. The control system for an automatic transmission of vehicle as claimed in claim 1, further comprising:
a speed change ratio setting means for setting the speed change ratio based on a vehicle speed and a torque demand for the vehicle.

23. A control method for an automatic transmission of vehicle, comprising:
a failure detecting of detecting a failure to set any of predetermined speed change ratios; and
a speed change commanding of outputting a speed change command to set a speed change ratio larger than the current speed change ratio in accordance with a signal outputted due to the fact that the failure is detected at the failure detecting.

24. A control system for an automatic vehicle transmission, comprising:
a failure detecting device for detecting a failure to set any of predetermined speed change ratios; and
a speed change commanding device for outputting a speed change command to set a speed change ratio larger than the current speed change ratio in accordance with a signal outputted when the failure detecting device detects the failure.

25. A control method for an automatic transmission of vehicle capable of controlling a deceleration of a vehicle by varying a negative torque opposite to a torque for running the vehicle, comprising:
a failure detecting of detecting a failure to set any of predetermined decelerations; and
a speed change commanding of outputting a deceleration command to set a deceleration greater than the current deceleration in accordance with a signal outputted due to the fact that the failure is detected at the failure detecting.

26. A control system for an automatic transmission of vehicle capable of controlling a deceleration of a vehicle by varying a negative torque opposite to a torque for running the vehicle, comprising:
a failure detecting device for detecting a failure to set any of predetermined decelerations; and
a speed change commanding device for outputting a deceleration command to set a deceleration greater than the current deceleration in accordance with a signal outputted when the failure detecting device detects the failure.
